(19) United States
(12) Patent Application Publication
(10) Pub. No.: US 2013/0205071 A1
(43) Pub. Date: Aug. 8, 2013

(54) COMPRESSED CACHE STORAGE ACCELERATION

(71) Applicant: Gauthaman Vasudevan, Old Bridge, NJ (US)

(72) Inventor: Gauthaman Vasudevan, Old Bridge, NJ (US)

(73) Assignee: Altior Inc.

(21) Appl. No.: 13/588,209

(22) Filed: Aug. 17, 2012

Related U.S. Application Data
(60) Provisional application No. 61/596,349, filed on Feb. 8, 2012.

(51) Int. Cl. G06F 12/08; G06F 12/02

(52) U.S. Cl. 711/103; 711/140; 711/E12.021; 711/E12.008

(57) ABSTRACT

In described embodiments, compressed cache storage acceleration employs compression and caching together in a combination to provide a performance gain. A layered file system includes a filter layer for the file system that selectively identifies and compresses data with the knowledge of the file structure before being stored in local cache memory or on a storage medium. Selection of compressed and uncompressed data for relatively immediate access is determined by monitoring access patterns and generating an access profile. The compressed and uncompressed data is locally stored and accessed in the cache, which might be Flash memory, to provide the performance gain.

### CROSS-REFERENCE TO RELATED APPLICATIONS

This application claims the benefit of the filing date of U.S. provisional application No. 61/596,349, filed on Feb. 8, 2012, the teachings of which are incorporated herein by reference.

### BACKGROUND OF THE INVENTION

1. Field of the Invention

The present invention relates to compression of data storage and data caching.

2. Description of the Related Art

In modern computer systems, accessing data from storage media (such as disks and tapes), or networked storage (such as Fiber Channel, iSCSI) and the like tend to exhibit high latency and limited throughput. Thus, many different techniques have been developed to accelerate storage access, which are then employed at various levels of the access path. These techniques include CPU caches to disk caches. Further, different techniques have been developed to increase the throughput for storage medium access by the use of parallel storage access. Parallel storage access includes the use of RAID devices and storage RAM buffers. RAM has long been used as a form of storage medium caches, but due to various reasons, the amount of RAM cache available for storage is usually limited. The critical layer along the data path during storage access is the file system layer.

Compression is a technique of reducing the data size to be stored and retrieved. Compression is applicable where pattern repetitions occur or if information is otherwise redundant. This compression of data reduces the data bandwidth required for transfer over the storage interface and time spent on accessing the data itself on the storage medium. Compression improves the storage throughput and reduces the latency depending on the compression algorithm and implementation. Caching is mechanism of storing high temporal and special locality data in high-speed, low-latency media. These high-speed, low-latency media, such as DRAM, SRAM and the like, are typically expensive.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention provides for transferring data between an application layer program and memory, by intercepting, by a compressed cache filter, attempts to access memory by an operating system to a file system, the attempts forming an access pattern associated with a given type of application layer program. A processor associated with the compressed cache filter generates an access profile identifying local data and storage media data. In response to one or more subsequent access requests, data corresponding to each subsequent access request is transferred between i) the operating system and ii) at least one of a cache memory and the storage media based on the access profile; wherein, the transferring between the operating system and the cache memory comprises compressing and decompressing, by the processor, one or more portions of the corresponding local data.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows an exemplary compressed cache storage system employing one or more exemplary embodiments of the present invention for compression;

FIG. 2 shows exemplary access profile and signature tables for the system of FIG. 1; and

FIG. 3 shows an exemplary method as might be employed by data stream processing system of FIG. 1.

### DETAILED DESCRIPTION

In accordance with exemplary embodiments of the present invention, data from an application layer is compressed at a file system level before transfer to a storage medium, reducing an amount of data transferred between the storage medium and the application layer, improving performance. A layered file system includes a filter layer of the file system that compresses data with the knowledge of the file structure before being stored on storage medium. Selection of compressed and uncompressed data for relatively immediate access is determined by monitoring access patterns and generating an access profile. The compressed and uncompressed data is locally stored and accessed in a cache, which might be Flash memory. Such caching of the data provides a mechanism of storing high temporal and special locality data in high-speed, low-latency media. As employed herein, the term “local data” refers to data identified for transfer between the local cache, and the terms “deep data” and “storage media data” refer to data that is not maintained locally, but rather provided to a file system for storage in, for example, an optical or magnetic storage medium.

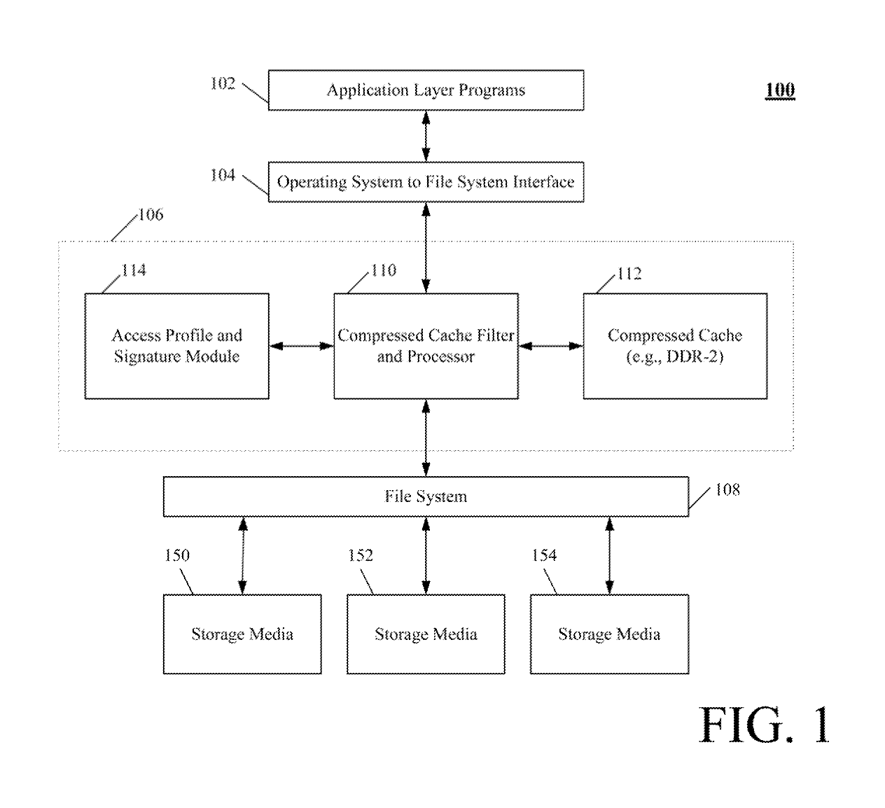

FIG. 1 shows an exemplary compressed cache storage system 100 employing one or more exemplary embodiments of the present invention for compression. Compressed cache storage system 100 comprises application layer programs (App-Layer) 102, operating system to file system (OS-FS) interface 104, compressed cache unit 106, file system (FS) 108, and storage media 150, 152, 154. Compressed cache unit 106, in turn, comprises compressed cache filter and processor 110, compressed cache memory 112, and access profile and signature module 114.

Compressed cache storage system 100 operates so that App-Layer 102 performs user-specified computing actions, which require access through read and write operations to data stored within storage media 150, 152, 154. Such user-specified computing actions might be performance of programs such as MS WORD® for word/document processing, RealPlayer® for playing video files, back-up programs for a server, database operation programs and the like. Consequently, App-Layer 102 performs such programs as a server, a lap-top computer, a mobile telephony device (e.g., a smart-phone or PDA or tablet), or any such computing device known in the art that accesses data read and written to memory.

Such access by App-Layer 102 might typically be through resident OS-FS interface 104, in communication with FS 108, which coordinates data transfer for programs operating at App-Layer 102 as required by the programs. FS 108, in turn, coordinates the reads and writes of data to the different storage media 150, 152, 154 based on the characteristics of the storage media and the architecture of the file system. Storage media 150, 152, 154 might each be embodied as, for example, an optical or magnetic storage drive, a tape drive, programmable memory, or other form of memory device.

When compressed cache filter and processor 110 intercepts access attempts by OS-FS interface 104, compressed cache filter and processor 110 determines an access profile for the program, either as a standalone operation, or by selecting by matching via a signature table an access profile predetermined and stored in memory. Operation of compressed cache unit 106, comprising compressed cache filter and processor 110, compressed cache memory 112, and access profile and signature module 114, is now described.

Compressed cache filter and processor 110, based upon access attempts by OS-FS interface 104, intercepts the access attempt and applies compressed cache storage acceleration in accordance with one or more embodiments of the present invention. Access attempts might correspond to read/write operations, status (e.g., byte size) requests, permission operations, or similar file system accesses. From these intercepted access attempts, compressed cache filter and processor 110 generates an access profile by looking for access patterns. File access might be classified with four situations: a read-read (R/R) of data, a read-write (R/W) of data, a write-read (W/R) of data, and a write-write (W/W) of data. In each of these four situations, compressed cache filter and processor 110 might examine how much data is read in sequence, how much data is read and then written, how much data is written and read back, and so forth. Further, compressed cache filter and processor 110 might examine how much data is thrown away or remains unused (the program writes but simply writes over or never accesses the data). In each situation, compressed cache filter and processor 110 is then able to determine how much data might be read ahead, and how much data might be made locally available uncompressed (UC) and how much data might be made locally available compressed (C).

For example, in a MS WORD® document currently in storage media that is accessed for word/document processing by an application program at App-Layer 102, data of a first section of a page might be might be made locally available uncompressed data as a set of UC data blocks, while data of a second section of a page might be made locally available as compressed data as a set of C data blocks. Other pages might be retained and made available by FS 108 by coordinating reads and writes of data of the other pages to the location in one of different storage media 150, 152, 154. For such other pages, FS 108 might perform such operations under control of compressed cache filter and processor 110.

Once compressed cache filter and processor 110 determines data that is to be stored locally as compressed data as C data blocks and as uncompressed data as UC data blocks, compressed cache filter and processor 110 partitions areas of compressed cache memory 112. Compressed cache filter and processor 110 applies a compression algorithm to the selected data blocks through any one of a number of compression algorithms known in the art. Compressed cache filter and processor 110 stores the C and UC data blocks accordingly at compressed cache memory 112. As required by access by App-Layer 102 through resident OS-FS interface 104, compressed cache filter and processor 110 then reads and writes data between OS-FS interface 104 and compressed cache memory 112 (unless the data is determined to be at a corresponding location in one of different storage media 150, 152, 154). When reading the compressed data C data blocks from compressed cache memory 112, compressed cache filter and processor 110 applies the inverse of the compression algorithm to provide uncompressed data.

For some data, compressed cache filter and processor 110 determines that the data is to be stored as “deep” data, or storage media data, because it is rarely accessed. For such storage media data, the data is provided from the OS-FS interface 104 to FS 108.

Compressed cache memory 112 is a cache memory for use by compressed cache filter and processor 110, and might be embodied as DRAM, SRAM, DDR DDR-2, FLASH, or similar high-speed, low-latency media. As such, the memory is employed to store either uncompressed or compressed data blocks depending on the control and requirements of compressed cache filter and processor 110.

Access profile and signature module 114 might be employed to store access profiles generated by compressed cache filter and processor 110. Since access profiles are generated for a particular application layer program, compressed cache filter and processor 110 uses the access profile to set up operation with compressed cache memory 112 when operation of the particular application layer program is detected. Further, by generating and examining various access profiles generated by various application layer programs over time, a series of “signatures” might be generated. In operation, a predefined access profile for a currently initiated application layer program might be rapidly selected by matching currently observed access patterns against entries of a signature table. Based on the matches of currently observed access patterns, access profiles associated with the signature table are searched and a “best match” selected for use. Consequently, access profile and signature module 114 might be employed employed to store signature tables for use by compressed cache filter and processor 110.

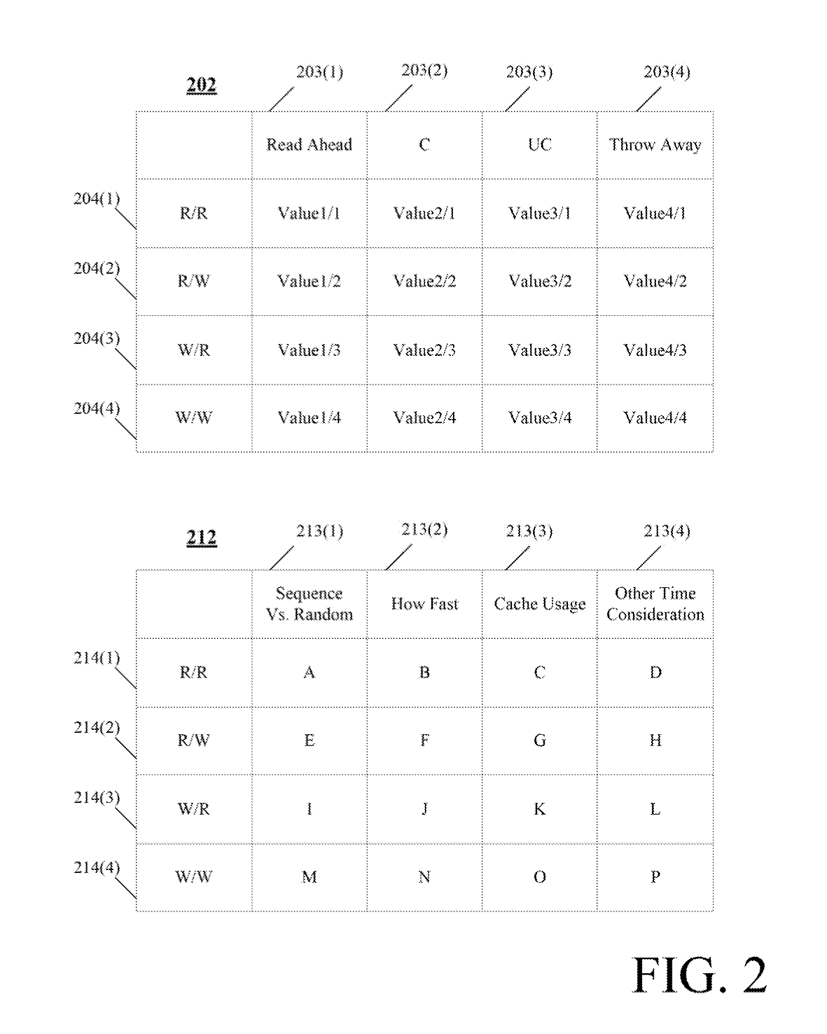

FIG. 2 shows exemplary access profile table 202 and signature table 212 for access profile and signature module 114 of the system of FIG. 1. For each of the Read and Write combinations, R/R 204(1), R/W 204(2), W/R 204(3) and W/W 204(4), a corresponding set of four parameters is maintained by profile table 202. The four parameters include an amount of blocks 203(1) that might be read ahead, a number of C blocks 203(2) that might be maintained as compressed data, a number of UC blocks 203(3) that might be maintained as compressed data, and a number of blocks 203(4) that are typically thrown away. Since data is parsed and compressed, some embodiments of the present invention might not be limited to a fixed block size for compressed and uncompressed data blocks. An advantage of the present invention is that some embodiments might vary the selected block size over time to improve performance, might select differing block sizes for compressed versus uncompressed data, and might select differing block sizes depending on specific programs running or varying requirements of App-Layer 102.

Signature table 212 is employed to match monitored access patterns of current application layer programs with a set of characteristics that can be associated with various access profiles. For each of the Read and Write combinations, R/R 214(1), R/W 214(2), W/R 214(3) and W/W 214(4), a corresponding set of at least four parameters is maintained by signature table 212. The four parameters include a characterization 213(1) of sequencing and randomness in the access patterns over time, an indication 213(2) of the speed, or how fast, access occurs over time, a characterization 213(3) of the cache memory usage that might be maintained over time, and other time-based considerations 213(4) that represent ways to characterize access patterns of a given application layer program. Note that multiple values might be included in 213(4).

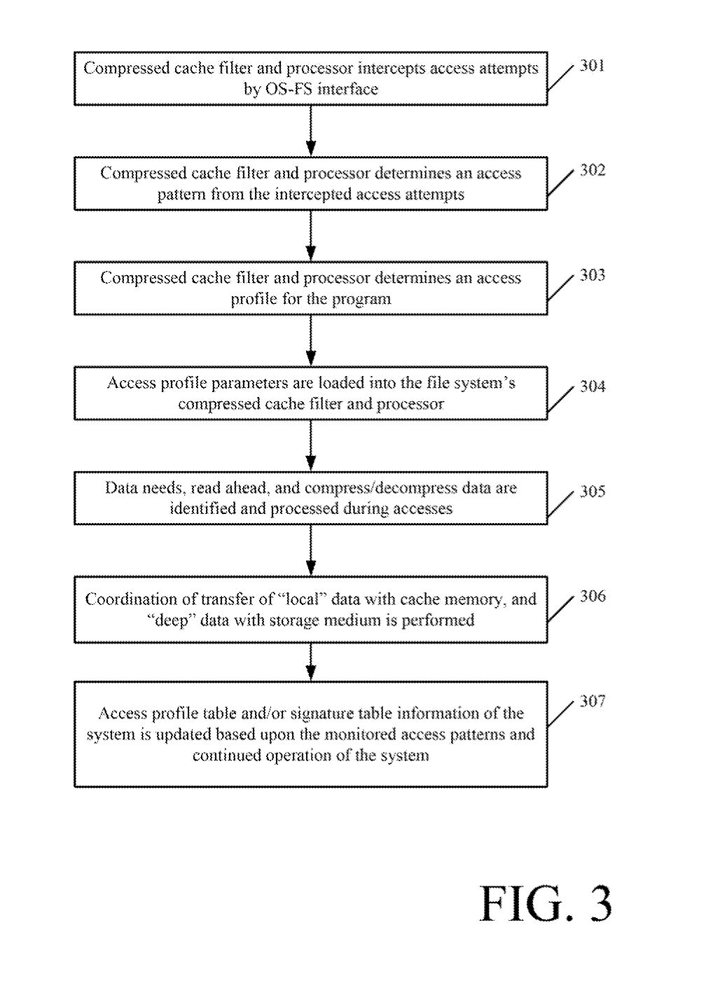

FIG. 3 shows an exemplary method 300 as might be employed by compressed cache unit 106 of FIG. 1. At step 301, compressed cache filter and processor 110 intercepts access attempts by OS-FS interface 104, and, at step 302, determines an access pattern from the intercepted access attempts. At step 303, compressed cache filter and processor 110 determines an access profile for the program, either as a standalone operation, or by selecting via a signature table an access profile predetermined and stored in memory.

At step 304, access profile parameters are loaded into the file system's compressed cache filter and processor. At step 305, based on intercepted access requests, the system's compressed cache filter and processor anticipates data needs, reads ahead, and performs compress/decompress of data during accesses. At step 306, which might occur concurrently with step 305, the system's compressed cache filter and processor coordinates transfer of “local” data with cache memory, and “deep” data with storage medium. Optionally, at step 307, the access profile table and/or signature table information of the system might also be updated based upon the monitored access patterns and continued operation of the system.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc. generated using a method and/or an apparatus of the present invention.

Unless explicitly stated otherwise, each numerical value and range should be interpreted as being approximate as if the word “about” or “approximately” preceded the value of the value or range.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. Signals and corresponding nodes or ports may be referred to by the same name and are interchangeable for purposes here.

No claim element herein is to be construed under the provisions of 35 U.S.C. §112, sixth paragraph, unless the element is expressly recited using the phrase “means for” or “step for.”

It will be further understood that various changes in the details, materials, and arrangements of the parts which have been described and illustrated in order to explain the nature of this invention may be made by those skilled in the art without departing from the scope of the invention as expressed in the following claims.

We claim:

1. A method of transferring data between an application layer program and memory, the method comprising:
intercepting, by a compressed cache filter, attempts to access memory by an operating system to a file system, the attempts forming an access pattern associated with a given type of application layer program;
generating, by a processor associated with the compressed cache filter, an access profile identifying local data and storage media data corresponding to the access pattern; and
transferring, in response to one or more subsequent access requests, data corresponding to each subsequent access request between i) the operating system and ii) at least one of a cache memory and the storage media based on the access profile;
wherein, the transferring between the operating system and the cache memory comprises compressing and decompressing, by the processor, one or more portions of the corresponding local data based on the access profile.

2. The method of claim 1, wherein, the transferring between the operating system and the cache memory comprises reading ahead of compressed local data, and determining throw away data from the access profile.

3. The method of claim 1, wherein the generating an access profile identifying local data and storage media data comprises matching characteristics of the access pattern based on at least one signature table.

4. The method of claim 3, wherein each signature table includes characteristics associated with Read/Read (R/R), Read/Write (R/W), Write/Read (W/R), and Write/Write (W/W) operations.

5. The method of claim 4, wherein the characteristics include sequencing versus randomness in data access, how fast data is accessed, cache usage of the cache memory, and data access time considerations.

6. The method of claim 1, wherein the access profile comprises a table identifying compressed blocks, uncompressed blocks, read ahead data and throw-away data associated with Read/Read (R/R), Read/Write (R/W), Write/Read (W/R), and Write/Write (W/W) operations.

7. The method of claim 1, wherein, for the transferring, the cache memory is a high-speed, low-latency media including at least one of a DRAM, an SRAM, a DDR, a DDR-2, and a FLASH memory.

8. The method of claim 1, further comprising updating the access profile based on the one or more subsequent access requests.

9. An apparatus for transferring data between an application layer program and memory, the apparatus comprising:
a compressed cache filter configured to intercept attempts to access memory by an operating system to a file system, the attempts forming an access pattern associated with a given type of application layer program;
a cache memory;
a processor associated with the compressed cache filter, the processor configured to:
i) generate an access profile identifying local data and storage media data corresponding to the access pattern;
ii) coordinate transfer, in response to one or more subsequent access requests, data corresponding to each subsequent access request between the operating system and at least one of the cache memory and the storage media based on the access profile; and
iii) compressing and decompressing, by the processor, one or more portions of the corresponding local data based on the access profile when transferring data between the operating system and the cache memory.

10. The apparatus of claim 9, wherein, when transferring data between the operating system and the cache memory, the processor is configured to read ahead of compressed local data, and to determine throw away data from the access profile.

11. The apparatus of claim 9, wherein, when generating an access profile identifying local data and storage media data, the processor is configured to match characteristics of the access pattern based on at least one signature table.

12. The apparatus of claim 11, wherein each signature table includes characteristics associated with Read/Read (R/R), Read/Write (R/W), Write/Read (W/R), and Write I Write (W/W) operations.

13. The apparatus of claim 12, wherein the characteristics include sequencing versus randomness in data access, how fast data is accessed, cache usage of the cache memory, and data access time considerations.

14. The apparatus of claim 9, wherein the access profile comprises a table identifying compressed blocks, uncompressed blocks, read ahead data and throw-away data associated with Read/Read (R/R), Read/Write (R/W), Write/Read (W/R), and Write/Write (W/W) operations.

15. The apparatus of claim 9, wherein the cache memory is a high-speed, low-latency media including at least one of a DRAM, an SRAM, a DDR, a DDR-2, and a FLASH memory.

16. The apparatus of claim 9, wherein the processor is configured to update the access profile based on the one or more subsequent access requests.

17. A non-transitory, machine-readable storage medium, having encoded thereon program code, wherein, when the program code is executed by a machine, the machine implements a method for transferring data between an application layer program and memory, comprising the steps of:
intercepting, by a compressed cache filter, attempts to access memory by an operating system to a file system, the attempts forming an access pattern associated with a given type of application layer program;
generating, by a processor associated with the compressed cache filter, an access profile identifying local data and storage media data; and
transferring, in response to one or more subsequent access requests, data corresponding to each subsequent access request between i) the operating system and ii) at least one of a cache memory and the storage media based on the access profile;
wherein, the transferring between the operating system and the cache memory comprises compressing and decompressing, by the processor, one or more portions of the corresponding local data.

18. The non-transitory, machine-readable storage medium of claim 17, wherein, the transferring between the operating system and the cache memory comprises reading ahead of compressed local data, and determining throw away data from the access profile.

19. The non-transitory, machine-readable storage medium of claim 17, wherein the generating an access profile identifying local data and storage media data comprises matching characteristics of the access pattern based on at least one signature table.

20. The non-transitory, machine-readable storage medium of claim 17, wherein the access profile comprises a table identifying compressed blocks, uncompressed blocks, read ahead data and throw-away data associated with Read/Read (R/R), Read/Write (R/W), Write/Read (W/R), and Write/Write (W/W) operations.
